(19) United States
(12) Patent Application Publication
(10) Pub. No.: US 2004/0260710 A1
(43) Pub. Date: Dec. 23, 2004

(54) Messaging system

(76) Inventors: Justin P. Marston, Preston (GB); Andrew S. Hatch, Darlington (GB)

Correspondence Address: FENWICK & WEST LLP, SILICON VALLEY CENTER, 801 CALIFORNIA STREET, MOUNTAIN VIEW, CA, 94041, US

(21) Appl. No.: 10/789,461

(22) Filed: Feb. 26, 2004

Related U.S. Application Data
(60) Provisional application No. 60/451,350, filed on Feb. 28, 2003.

(51) Int. Cl. G06F 17/00

(52) U.S. Cl. 707/100; 340/7.52

(57) ABSTRACT

A messaging system uses a relational model to represent messages exchanged among end-users of the system. A message within the system contains one or more submessages. A contents module stores data describing the content of each message and submessage. An attributes module describes the attributes possessed by the messages and submessages. A relationships module describes the relationships among the messages and submessages. Because submessages are separate from the messages that contain them, different policies can be applied to individual submessages. Moreover, the messaging system stores each object (e.g., message or submessage) only once. The messaging system thus significantly reduces infrastructure costs by removing unnecessary duplicity, and provides enterprises with the content granularity they need to enforce regulatory compliance and other policies.

### CROSS-REFERENCE TO RELATED APPLICATION

This application claims the benefit of U.S. Provisional Application No. 60/451,350, filed Feb. 28, 2003, which is hereby incorporated by reference herein.

### BACKGROUND

1. Field of the Invention

This invention pertains in general to electronic messaging systems and in particular to a system using a relational model to store messages.

2. Background Art

Before the introduction of e-mail, business users relied on two forms of communication—the phone and the business letter. The former was momentary and casual, the latter was retained as a business record and was considered formal. E-mail has blurred those two communication requirements into one tool—people use it both formally and casually, but it is retained for an indefinite time period (typically years) depending on how an enterprise's Information Technology (IT) system has been set up.

Enterprises are now searching for a way to deal with the problem of separating communications that constitute business records from the general ‘chatter’ of e-mail. Such business records must be retained in a manner that reflects the business processes to which the content relates.

A further problem with current e-mail systems is that messages are just simple text strings. When a user writes a message, it is formed into the first e-mail, but may then go on to be included in many other e-mails during its lifetime. This results in many copies of the same, user-authored, message in different, unrelated, mail “snapshots.” Enforcing a retention policy, access rights, security or any other property onto messages thus becomes impossible, as the content cannot be tracked through all of its separate instances in the mail system. This is a very significant problem for companies attempting to achieve regulatory compliance with internal or government-mandated regulations.

Moreover, a typical enterprise, such as a law office, relies on multiple separate software applications to perform its business processes and capture its workflow. For example, the enterprise may use a word processing program to create documents, a document management program to store the documents, a time tracking application to record time for billing purposes, and an accounting program to bill customers. When the members of the enterprise use the applications, the applications typically do an adequate job of fulfilling the business processes and tracking the specific types of workflow to which the applications are directed. For example, a typical document management program usually performs an adequate job of managing documents created by the enterprise. However, members of the enterprise often resist using workflow-capturing applications because of the extra overhead that the applications introduce. As a result, the members might not use the document management program because it requires too much time and/or effort to check documents into, or out of, the system.

Electronic messaging applications are popular business process tools for enterprises because the applications are easy to use and require low overhead. For example, it is usually easier for a person to send a quick email to another person than to draft a memo, store the memo using the document management program, and then print and deliver a copy of the memo. However, electronic messaging applications lack sophisticated workflow-capturing abilities. Consequently, much of an enterprise's workflow remains uncaptured due to peoples' heavy reliance on electronic messaging. Therefore, the enterprise cannot effectively perform auditing, compliance checking, and other tasks that require sophisticated workflow capture. Accordingly, there is a need in the art for a electronic messaging tool that is easy to use, has low overhead, and provides sophisticated workflow-capturing and auditing abilities.

### SUMMARY OF THE INVENTION

A messaging system uses a relational model to represent messages exchanged among end-users of the system. A message within the system contains one or more submessages. A contents module stores data describing the content of each message and submessage. An attributes module describes the attributes possessed by the messages and submessages. A relationships module describes the relationships among the messages and submessages. Because submessages are separate from the messages that contain them, different policies can be applied to individual submessages. Moreover, the messaging system stores each object (e.g., message or submessage) only once. The messaging system thus significantly reduces infrastructure costs by removing unnecessary duplicity, and provides enterprises with the content granularity they need to enforce regulatory compliance and other policies.

### BRIEF DESCRIPTION OF THE DRAWINGS

FIG. 1 is a high-level block diagram illustrating an environment for exchanging messages according to an embodiment of the present invention.

FIG. 2 is a block diagram showing the structure of an S-Mail for use with the messaging system according to one embodiment;

FIG. 3 is a transaction diagram showing how S-Mails are transferred in one embodiment of the environment including the messaging system;

FIG. 4 is a block diagram illustrating modules and relationships within the message system for handling S-Mails according to an embodiment of the messaging system; and

FIG. 5 is a block diagram illustrating a more detailed view of a configuration of data in the database module according to one embodiment.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

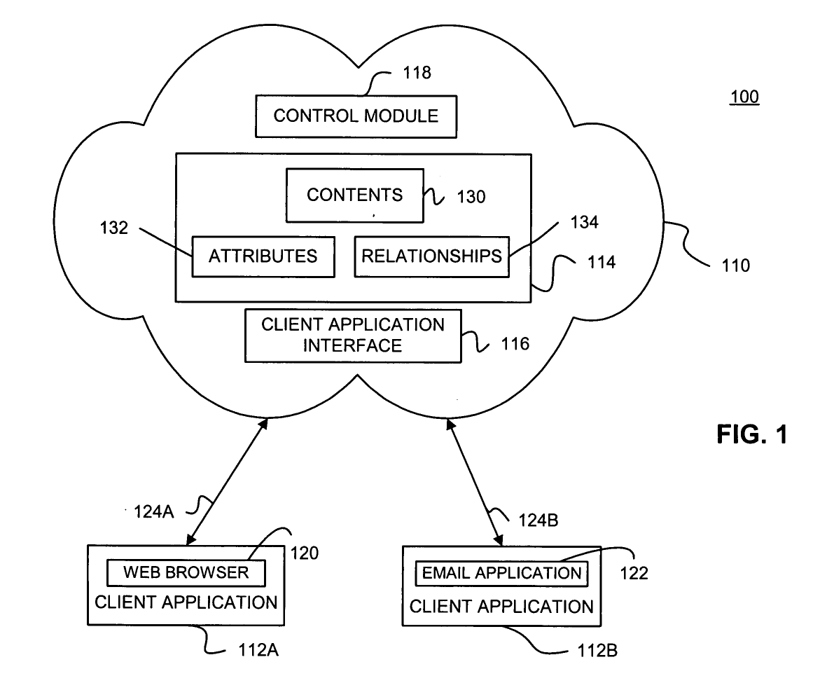

FIG. 1 is a high-level block diagram illustrating an environment 100 for exchanging messages according to an embodiment of the present invention. The environment includes a relational messaging system 110 and two client applications 112. In the text, a letter after a reference numeral, such as “112A,” indicates that the text refers specifically to the element having that particular reference numeral. A reference numeral in the text without a following letter, such as “112,” refers to any or all of the elements in the figures bearing that reference number (e.g. “112” in the text refers to reference numerals “112A” and “112B”).

The relational messaging system 100 provides a relational data store that can be accessed by the client applications 112 and other application modules to provide electronic messaging functionality. That is, it allows end-users of the client applications 112 to exchange messages with end-users of other clients applications. As used herein, a person, computer, program module, or other entity that utilizes the data in the relational data store is referred to as an “end-user.” Typically, the end-user will access the data through an interface provided by a program module such as an email program, a web browsing program, or an instant messaging program. The program module that provides the interface is referred to as a “client application.” This description refers to a message exchanged via the relational messaging system 100 as an “S-Mail.” An S-Mail can include and/or resemble an email message, a message exchanged via an instant messaging system, or another type of message typically sent via computer systems. In addition, an S-mail can include and/or resemble an audio and/or video message.

In one embodiment, the relational messaging system 110 is remote from some or all of the client applications 112 and/or end-users and communications are exchanged between these entities using a wide-area computer network such as the Internet. For example, in one embodiment the client application 112 is delivered to end-users by an application service provider (ASP) operating a remote web server. This remote server can also store the relational messaging system 110. In another embodiment, relational messaging system 110 is executed on a computer system located on a local area network proximate to the end-users. In this latter embodiment, an end-user can access the relational messaging system 110 via a client application 112 executing on a local computer system. Other embodiments utilize variations of the local/remote aspects described above.

In one embodiment, the relational messaging system 110 is implemented on one or more conventional computer systems having processors, memories, storage devices, network interfaces, etc. The computer systems execute a variety of modules to provide the messaging functionality. In one embodiment, the modules include a database module 114, a client application interface module 116, and a control module 118. As utilized herein, the term “module” refers to computer program logic and/or any hardware or circuitry utilized to provide the functionality attributed to the module. Thus, a module can be implemented in hardware, firmware, and/or software. Embodiments of the relational messaging system 110 (and the client applications 112) can have different and/or additional modules than the ones described herein. Moreover, in different embodiments the functionalities of the relational messaging system 110 (and client applications 112) are distributed throughout the modules in a manner different than described herein.

In general, the database module 114 (often referred to herein as the “database” or a “data store”) stores data modules describing contents 130, attributes 132, and relationships 134 for the S-Mails exchanged via the relational messaging system 110. One of skill in the art will recognize that the data modules represent types of data in the database module 114, and, in fact, the data may not be organized in distinct “modules.” In one embodiment, the database module 114 includes a relational database and the data are organized as sets of tables from which data can be accessed or reassembled in many different ways without having to reorganize the tables. In addition, the database module 114 preferably holds all information in an encrypted form in order to provide enhanced security.

In one embodiment, the database module 114 includes a contents module 130 holding data describing S-Mails and the contents of the S-Mails utilized in the messaging system 110. In one embodiment, an S-Mail is formed from one or more “submessages.” Each submessage can include text messages, graphics, audio data, video data, or other information. The contents module 130 stores each submessage as a discrete object that can be individually referenced. In addition, the contents module 130 stores attachments to submessages, which are data of any type (e.g., images, video, text), as discrete, individually-referenced objects. In one embodiment, the contents module 130 stores an S-Mail as a discrete object that can be individually referenced. The S-Mail object, in turn, references the sub-message objects and/or attachments in the contents module 130 that form the S-Mail.

The database module 114 also includes an attributes module 132 that describes attributes of the various objects and entities in the messaging system, including S-Mails, submessages, attachments, client applications 112, and/or end-users. The attributes can describe, for example, the creator of an object, to whom the object was sent, job codes or other tracking information associated with the object, the end-user rights with respect to the object, etc. The attributes can also describe location information. For example, the location information can describe different policies to apply to the objects and/or entities based on the location of the object and/or entity. For example, the location information can indicate that a particular submessage object can be viewed by a particular end-user only when that end-user is in a given location. The attributes can also describe security and encryption information for the various objects and entities in the messaging system such as passwords, encryption algorithms, and key lengths.

In one embodiment, the attributes module 132 stores attributes describing the validity and/or retention policy for an object or entity in the messaging system. A validity policy describes the length of time for which the object or entity is effective. In the case of an S-Mail or submessage, the validity policy describes the length of time for which the S-Mail or submessage is visible to the end-users of the messaging system 110. A retention policy describes the length of time for which an object or entity is retained by the messaging system. For example, for an S-Mail or submessage, the retention policy describes the length of time before the S-Mail or submessage is permanently deleted from the messaging system. The validity and retention policies are not necessarily the same. For example, an submessage having an expired validity policy but valid retention policy will not be visible to the end-users of the messaging system 110 yet will still be retained by the system.

A relationships module 134 in the database module 114 holds data describing the relationships among the various objects and entities in the messaging system, including S-Mails, submessages, attachments, client applications 112, and/or end-users. For example, in one embodiment the relationships module 134 holds data describing the submessages that are within each S-Mail. The relationships module 134 can also hold data placing the objects and entities into one or more domains, such as domains specifying roles, workgroups, compliance groups, etc. The relationships module 134 can also hold data implementing policies on the objects and entities. For example, the data may specify that certain end-users cannot send S-Mails to other end-users, and/or that a submessage object cannot be viewed by users in a certain workgroup, in order to comply with an ethical screen.

The client application interface module 116 provides functionality allowing the messaging system 110 to communicate with the client applications 112. The client interface module 116 can support multiple communications techniques including web-based and email-based techniques. In one embodiment, the client application interface module 116 provides web server functionality allowing client applications 112 to communicate using conventional web-based protocols, including the hypertext transport protocol (HTTP), the secure HTTP (S-HTTP), the secure sockets layer (SSL), etc. In one embodiment, the client application interface module 116 provides email-based functionality allowing client applications 112 to communicate using standard email protocols and interfaces. For example, the client interface module 116 can support the Messaging Application Programming Interface (MAPI), the Internet Message Access Protocol (IMAP), and/or the Post Office Protocol (POP). An embodiment of the client application interface module 116 also supports instant messaging protocols and interfaces.

In one embodiment, the client application interface module 116 includes functionality for accessing the data in the database module 114 and presenting the data to the client application 112 in a format “expected” by the client application. Preferably, this functionality allows the client application interface module 116 to simulate the operation of a conventional messaging server through queries on the database module 114. For example, a typical email client application 112 has separate data stores for an in-box, an out-box, deleted items, etc. and certain types of email servers identify the messages in each of these data stores. The client application interface module 116 includes logic for querying the database module 114 to identify S-Mails that “belong” in these data stores, thereby simulating the behavior of the email server.

The control module 118 controls the operation of the relational messaging system 110. To this end, the control module 118 performs and/or supports functions including authenticating clients applications 112 and/or end-users, creating, reading, editing, and forwarding S-Mails in the database module 114 in response to client application 112 and/or end-user interactions, executing queries on data in the database 114, and communicating with the client applications via the client application interface 116. The operation of the control module 118 is described in greater detail below in reference to the overall operation of the relational messaging system 110.

As described above, a client application 112 is utilized by an end-user to access the messaging functionality of the relational messaging system 110. In one embodiment, the client application 112 executes on a conventional computer system. In other embodiments, the client application 112 executes on a personal electronic device such as a cellular telephone, pager, personal digital assistant, etc. Although only two client applications 112 are illustrated in FIG. 1, embodiments of the environment 100 can have any number of client applications and end-users.

In the environment 100 of FIG. 1, one of the client applications 112A includes a web browser module 120. In one embodiment, the web browser module 120 is a conventional web browser application program, such as INTERNET EXPLORER from MICROSOFT CORP. In another embodiment, the web browser module 120 is embedded within an operating system or within an application program having a primary purpose other than web browsing. The end-user uses the web browser module 120 to communicate with the relational messaging system 110.

The other client application 112B illustrated in the environment 100 of FIG. 1 includes an email application module 122. In one embodiment, the email application module 122 is a conventional email program, such as MICROSOFT OUTLOOK. In another embodiment, the email application module 122 is embedded within an operating system or within an application program having a primary purpose other than web browsing.

In one embodiment, the client application 112 utilizes both a web browser module 120 and an email application module 122 to access the relational messaging system 110. The relational messaging system 110 can be configured to send the client application 112 a standard email notifying the end-user that an event has occurred on the system, such as that the end-user has received an S-Mail. In this example, the client 112 receives the standard email using the email application module 122 but uses the web browser module 120 to access the relational messaging system 110. In another example, the relational messaging system 110 sends the client application 112 a notification using another technique, such as by sending a message causing the client application 112 to update an icon on a toolbar or present a dialog box, sending a MACROMEDIA FLASH message that displays a notice to the end-user, etc.

In one embodiment, additional program modules in the client application interface 116, client applications 112, or elsewhere in the system 110 provide integration with additional enterprise workflow applications and processes. These modules utilize the database 114 as a relational data store for the information exchanged by these other workflow applications and processes.

The network links 124 between the clients 112 and the relational messaging system 110 preferably utilize conventional wired and/or wireless technologies such as Ethernet, 802.11, etc. In addition, the clients 112 and relational messaging system 110 preferably communicate using conventional networking protocols, including the transmission control protocol/Internet protocol (TCP/IP), HTTP, IMAP, MAPI, POP, etc. In one embodiment, the links 124 are secured from eavesdropping using conventional encryption technologies, including SSL and/or S-HTTP. The links 124 can include public links, such as the Internet, and private links, such as links over a LAN at an office or other enterprise.

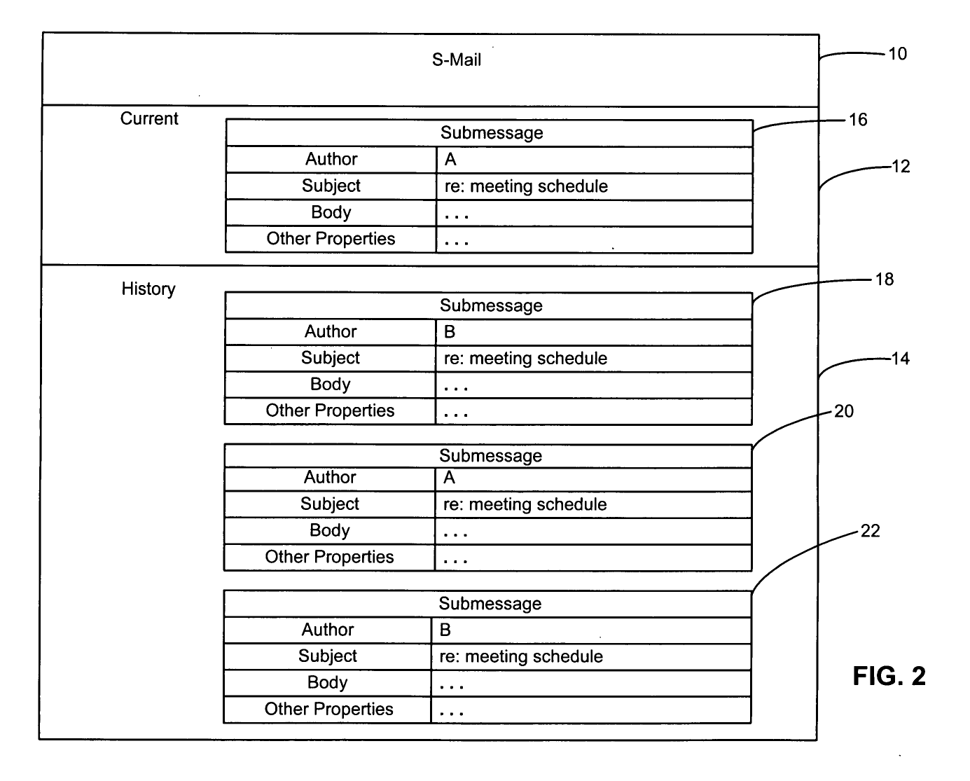

FIG. 2 is a block diagram showing the structure of an S-Mail for use with the messaging system according to one embodiment. Unlike a traditional email, which is essentially just a text string with associated headers which is sent between computers, an S-Mail may more accurately be thought of as a database entry holding references to data (e.g., submessages) in the database module 114. As shown in FIG. 2, an S-Mail 10 in one embodiment includes two portions: a current portion 12 and a history portion 14. Within the current portion is a current submessage 16 which is that message which is the main message for this S-Mail, in other words the message which the sender of the S-Mail wishes to convey to the recipient.

The history portion 14 contains a list of individual submessages 18,20,22 which set the context for the current submessage 16. Typically, the history submessages reflect the history of the correspondence as S-Mails are passed back and forth between two or more end-users. Thus, the entire course of the correspondence can be followed by looking at each of the history submessages in order.

More formally, in one embodiment an S-Mail is defined as a pair: (current, history) where current is a submessage, and history is a list of submessages. In other embodiments, the one or more submessages within an S-Mail are not arranged in a (current, history) relationship. In one embodiment, a submessage includes the following fields:

Submessage

| property | Description |
|---|---|
| Author | this is a reference to a user. |
| Recipient | this is a reference to the one or more recipients of the |
| | message. |
| creation date | the date and time which the message first came into being, |
| | even before the message body has been written. |
| sent date | the date and time which the message was sent to the |
| | recipient. |
| Priority | an indicated level of priority, on a scale of 1 (lowest |
| | priority) to 5 (highest priority). |
| sensitivity | an indication of the level of sensitivity which this document |
| | should be treated with. In one embodiment, this is |
| | represented on a scale of 1 (not sensitive) to 10 (highly |
| | sensitive). |
| Subject | a short description of the subject of the message, similar to |
| | ‘subject’ in an email. |
| Body | the body of the submessage. |
| forwardable | a flag to indicate whether this submessage should be |
| | allowed to be forwarded to users other than those specified |
| | as recipients for this submessage (see later). |
| Printable | a flag to indicate if this submessage should be presented |
| | with measures to reduce the likelihood of it being printed. |
| savable | a flag to indicate if this submessage should be presented |
| | with measures to reduce the likelihood of it being saved. |
| | Otherwise facility will be presented to allow the message to |
| | be saved in plaintext. |
| Job Codes | one or more fields that hold codes that can be used to index |
| | the message given the particular business processes and/or |
| | workflows utilized by the client application, end-user, |
| | and/or end-user's enterprise. |

Each submessage may have a list of associated attachments, attachments being files which are sent from the author to the recipient along with the current submessage. To ensure that a complete record of the correspondence history is maintained, history sub-documents may also include lists of attachments, where those attachments had been sent earlier on in the correspondence.

Attachments can have the following properties:

Attachment

| property | Description |
|---|---|
| filename | the filename. Appropriate restrictions can be made |
| | on the characters which make up a filename. |
| size | the length, in bytes, of the file. |
| data | the data of the file. |
| access history | the times and dates of when the attachment was |
| | accessed, and the identity of the client |
| | application/end-user that accessed it. |
| filter status | whether the attachment has passed through a one or |
| | more filters, such as a virus detection filter. |

For each submessage, and for each recipient, information is stored on the recipient name, along with date/time stamps when the submessage was read, replied to and forwarded. This timing information allows the system, where required, to report back to the sender of an S-Mail 10 information on whether (and, if so, when) the S-Mail was read, replied to, and forwarded by each of the recipients of the S-Mail.

Thus, an S-Mail includes a pointer (i.e., a reference) to the locations of the current submessage 16, along with pointers to any history submessages 18,20,22. Whenever an end-user sends an S-Mail, the current submessage 16 is stored in the database 114 with the appropriate data fields indicating the properties of the S-Mail. When the S-Mail is received and viewed by the recipient, the system 110 retrieves the current message from the database 114, and displays it. Any attachments are likewise stored in the database 114, and are retrieved from there when a request to view or open an attachment is made by the recipient.

If the recipient then wishes to reply to the S-Mail, he selects a “Reply” function. This function 112 interacts with the client application interface 116 to create records the database 114 for a new S-Mail in which the original text is converted into a history submessage. The recipient then composes and sends a new current message, for the reply, and the client application interface 116 creates the appropriate records in the database 114. When the sender opens the reply, the system 110 automatically reads through the database records/S-Mail references in sequence and retrieves the various submessages from the database 114. In the example given, the new current submessage is automatically retrieved from the database 114, and the history submessage (the message that started the correspondence) is retrieved from the database.

In more complex situations, there may be multiple recipients and multiple senders, but the same principle applies: each submessage together with any attachment is stored only once in the database 114.

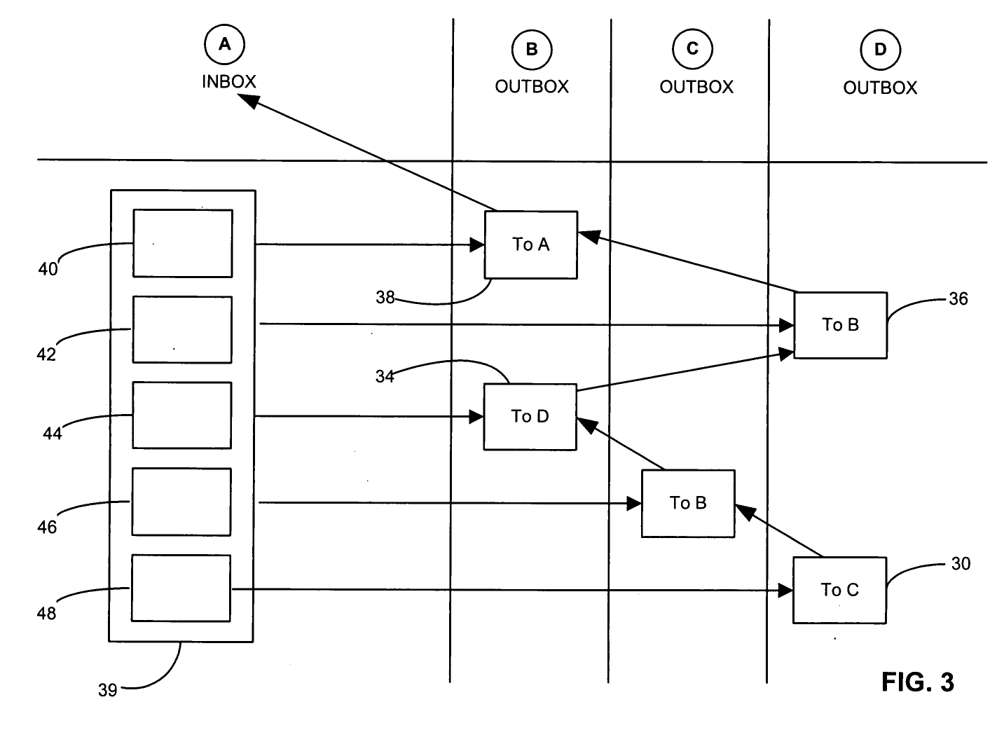

FIG. 3 is a transaction diagram showing an example of how S-Mails are transferred in one embodiment of the relational messaging system 110. Here, four parties are engaged in a conversation by S-Mail. For simplicity, the inbox of Party A is shown, and only the outboxes of Parties B, C and D. One of skill in the art will recognize that the inbox and outboxes are in fact logical entities formed from the relational records stored in the database 114.

Party D starts the conversation by sending an S-Mail to C. The text of that S-Mail 30 is automatically stored in D's outbox. C opens the S-Mail, reads it, adds a new current submessage 32 of his own, and forwards the resultant S-Mail on to B. The new submessage 32 added by C is stored in C's outbox. Similarly, B adds his own submessage 34, and sends the correspondence back to D. D adds a further submessage 36 which is stored once again in his outbox, and replies to B. Finally, B adds another submessage 38 and forwards the correspondence to A.

As a result of the exchange, A receives in his inbox an S-Mail 39 containing pointers to a number of submessages. The first pointer 40 corresponds to the current submessage 38 which may be found in B's outbox. The other pointers 42 to 48 all point to history submessages which may be retrieved, as shown, from their respective original author's outboxes. When A opens the S-Mail 39, the relational messaging system 110 preferably automatically retrieves the submessages from the assorted outboxes and presents them. In one embodiment, the relational messaging system 110 displays the messages in a manner that resembles a conventional email that has been forwarded multiple times.

Since each submessage is stored only once on the system, storage requirements are minimized. Bandwidth requirements are also reduced since it is not necessary to transmit to a recipient the text of any particular submessage (or attachments) unless the recipient needs them. Depending upon the way the system 110 is configured, the opening of an S-Mail by a recipient does not necessarily automatically open and display all of the history submessages. In some embodiments, only the current submessage may be retrieved automatically, with the history submessages and their attachments being retrieved only when explicitly requested.

In one embodiment, once an S-Mail has been sent, nobody is permitted to amend the content of any of its constituent submessages (including those stored within an author's own logical outbox). Thus, end-users cannot falsify or otherwise change in any way S-Mails that have already been exchanged. Similarly, since the histories are created automatically, individual history submessages cannot be deleted and selective quotation is impossible. A further advantage is that version control of neither submessage nor attachment is required: each current submessage in every S-Mail, along with any attachments, is stored on the database module 114, and can never be changed or moved under normal end-user control.

Indeed, to maintain database integrity, and to ensure that complete histories are always available, in one embodiment the system 110 never allows end-users to delete from the database module 114 either sent or received S-Mails. However, to prevent end-users' logical inboxes and outboxes becoming filled with S-Mails that are no longer of interest, end-users do have what appear to them to be delete options; in practice, any S-Mails “deleted” by the end-user are simply hidden from view, while still being maintained within the underlying database module 114.

Before replying to an S-Mail, or forwarding it, the system 110 may allow the end-user to purge from the S-Mail the oldest of the history submessages. This does not affect the content of the submessages themselves (which remain in the database 114), but it allows the end-user to forward for example the final agreed version of a document without necessarily allowing the recipient to see any earlier draft versions. Depending upon the application, in some embodiments the end-user may be able to choose to forward some, but not all, of the history submessages. In other embodiments, to prevent “selective quotation,” the end-user may be forced to forward all history submessages or all history submessages older than a particular chosen submessage. In the latter case, the end-user can choose to omit the oldest history submessage or submessages, but cannot selectively send some of the older submessages while at the same time omitting some of the more recent ones.

Some embodiments of the system 110 operate in different manners than the ones described above. In one embodiment, the system 110 allows an end-user to selectively retract S-Mails. In this embodiment, the system 110 preferably edits the audit trail for a retracted S-Mail to reflect the retraction or make it appear as if the S-Mail was never sent. In one embodiment, the retracted S-Mail is still stored in the database 114.

In one embodiment, a compliance module (not shown) in the system 110 can actually delete S-Mails and/or submessages from the database 114. When an S-Mail is deleted, changes reflecting the absence of the S-Mail are propagated through the database 114. In one embodiment, when a submessage is deleted, any S-Mail that references that submessage indicates “This content is no longer available,” but other submessages that have not been deleted are still shown as part of the S-Mail. It is anticipated that only certain client applications 112 and/or end-users will have permission to use the compliance module to delete S-Mails.

Submessages may have associated with them a variety of different attributes, which control the way in which the submessage is displayed, the actions a recipient can carry out on it, the parties/departments/geographies that are allowed to access it at any point during its lifetime, the tools that can be used to forward it, the period for which it is retained before deletion, the period for which it is valid (e.g. an Human Resources policy may be valid for one year but retained for longer), and the level of security/encryption that should be applied to it, e.g., the encryption protocol and key length., or can be used by the recipient. These attributes can be varied according to the business processes to which the content relates, and can take both internal and external triggers. For example, the period of time for which a submessage is retained by the system can be made to be, “for 3 years after the time at which the customer closes their account with us.” Such a system might rely on an external customer account system to determine when the customer closes their account. These attributes are preferably stored in the attributes module 132 of the database module 114. Attributes include the following:

Priority:

Rules may be defined within the system 110 to deal differently with incoming S-Mails in dependence upon the priority the author has applied to the current submessage. Allowance for the operation of rules may also be provided; for example, the system 110 may automatically send the recipient a conventional email, advising him that an S-Mail has been received, and inviting him to logon to the secure messaging system to view it. Different senders may automatically be allocated different priority settings, so that for example an S-Mail received from an end-user working on a very important and time- sensitive piece of work may have higher priority over more general S-Mails. Assignment of priority ratings can thus be shared between recipient and sender.

Thus, priority ratings may affect the way in which the end-user is notified of the arrival of an S-Mail. For example, an urgent S-Mail might result in the recipient receiving an immediate email or other alert that an S-Mail has arrived. Non-urgent S-Mails, on the other hand, might only be indicated in hourly or daily email summaries.

Message Sensitivity:

Blocking viewing rights: submessages may be marked as unviewable by particular end-users or groups of end-users. Thus, the author of a submessage can ensure that if it ever becomes part of the history contained within another S-Mail, it will still not be visible by certain end-users. Such policies can be enforced through the compliance module discussed earlier.

Preventing forwarding: An author of a submessage may set a flag which prevents that message from being forwarded. When the flag is set, that submessage can never become a history submessage within another S-Mail.

Prevent saving: This flag prevents a recipient from downloading the submessage from the database, and saving it on the local hard disk or elsewhere. The system 110 may also prevent the usual “cut and paste” functions from working to prevent an end-user from copying a submessage.

This description now illustrates some of these concepts by means of a few examples. The table below shows where Harry and Bob are talking to each other through a reply string. A,B,C,D,E are all submessages. 1,2,3,4,5 are all generations of S-Mails generated through actions—such as a user replying to an S-Mail. The notation of, say, “C|B,A” means the current submessage C with history B and then A. “|” effectively means “given”. The “Inbox” and “Sent” headings represent logical views into the database 114.

| | | | | | Carol | |
|---|---|---|---|---|---|---|
| Action | Harry (user 1) | | Bob (user 2) | | (user 3) | |
| Number | Inbox | Sent | Inbox | Sent | Inbox | Sent |
| 1 | | A | A | | | |
| 2 | B\|A | | | B\|A | | |
| 3 | | C\|B, A | C\|B, A | | | |
| 4 | D\|C, B, A | | | D\|C, B, A | | |
| 5 | | E\|D, C, B, | E\|D, C, B, A | | | |
| | | A | | | | |

Description:
1. Harry sends S-mail to Bob
2. Bob replies to it
3. Harry replies
4. Bob replies
5. Harry replies

The below example is slightly more complex. It involves forwarding the same pattern to Carol.

| Action | Harry (user 1) | | Bob (user 2) | | Carol (user 3) | |
|---|---|---|---|---|---|---|
| Number | Inbox | Sent | Inbox | Sent | Inbox | Sent |
| 1 | | A | A | | | |
| 2 | B\|A | | | B\|A | | |
| 3 | | C\|B, A | C\|B, A | | | |
| 4 | | D\|B, A | | | D\|B, A | |
| 5 | E\|C, B, A | | | E\|C, B, A | | |
| 6 | | F\|E, C, | F\|E, C, | | | |
| | | B, A | B, A | | | |
| 7 | G\|D, B, A | | | | | G\|D, B, A |

Description:
1. Harry sends S-mail to Bob.
2. Bob replies to it.
3. Harry replies.
4. Harry forwards the B|A S-mail to Carol.
5. Bob replies to Harry.
6. Harry replies.
7. Carol replies to Harry.

So this shows that at action 3, Harry sent C|B,A to Bob, but then Harry forwarded the S-Mail to Carol in action 4 with a different current submessage. So Carol receives D|B,A. Bob never gets to see D because it is on a different S-Mail string—it was never sent to him. Finally Carol replies to Harry in action 7.

Each of these action numbers generates S-Mails. The letters (A,B,C . . . ) are submessages. Submessages only exist once, and S-Mails are like windows to them. So in the example above, at the end of action 7, Bob can see submessage A via his inbox in three different S-Mails and in his sent folder via the two S-Mails he sent.

Next this description examines savable/non-savable S-Mails, and the fact that they make no difference to S-Mail histories. The symbol + means savable and − means non-savable—this notation is purely to indicate message flows below:

| Action | Harry (user 1) | | Bob (user 2) | | Carol (user 3) | |
|---|---|---|---|---|---|---|
| Number | Inbox | Sent | Inbox | Sent | Inbox | Sent |
| 1 | | A⁺ | A⁺ | | | |
| 2 | B⁻\|A⁺ | | | B⁻\|A⁺ | | |
| 3 | | C⁺\|B⁻, A⁺ | C⁺\|B⁻, A⁺ | | | |
| 4 | | D⁺\|B⁻, A⁺ | | | D⁺\|B⁻, A⁺ | |
| 5 | E⁻\|C⁺, | | | E⁻\|C⁺, | | |
| | B⁻, A⁺ | | | B⁻, A⁺ | | |
| 6 | | F⁺\|E⁻, | F⁺\|E⁻, | | | |
| | | C⁺, B⁻, A⁺ | C⁺, B⁻, A⁺ | | | |
| 7 | G⁺\|D⁺, | | | | | G⁺\|D⁺, |
| | B⁻, A⁺ | | | | | B⁻, A⁺ |

Description:
1. Harry sends S-Mail to Bob.
2. Bob replies to it, but makes the reply non-savable.
3. Harry replies but lets other people save his sub-message (i.e. makes it savable).
4. Harry forwards the B|A S-Mail to Carol, again making it savable.
5. Bob, being paranoid, again makes his replying submessage non-savable.
6. Harry replies but makes his submessage savable.
7. Carol replies to Harry, making her submessage savable.

The above table indicates whether S-Mails in the example given are savable. In the example, submessage B is always non-savable, as indicated by the suffix. Whenever it appears, in whatever inbox or outbox of any end-user, it can never be saved as a text file. Whereas A can always be saved out as a text file, wherever it appears, as indicated by the+suffix. Neither of these states makes any difference whatsoever to whether these submessages can be forwarded. Both can be or cannot be forwarded, depending on their attributes. The above example assumes that all submessages are forwardable, as have all examples so far. Savable S-Mails simply means that they can be saved as a text file by clicking on a provided hyperlink. Those which are non-savable do not have the link and clicking on the non-savable icon displays a message stating that the message cannot be saved by the user.

This description shall now ignore whether submessages are savable or not, as it is irrelevant to forwarding and replying issues. The final example we shall use is to demonstrate forwardable and non-forwardable principles. In this example, the suffix *indicates that a submessage is forwardable, e.g. A*, and the suffix \hat{ } indicates non-forwardable.

| Action | Harry (user 1) | | Bob (user 2) | | Carol (user 3) | |
|---|---|---|---|---|---|---|
| Number | Inbox | Sent | Inbox | Sent | Inbox | Sent |
| 1 | | A* | A* | | | |
| 2 | B\hat{ }\|A* | | | B\hat{ }\|A* | | |
| 3 | | C*\|B\hat{ }, A* | C*\|B\hat{ }, A* | | | |
| 4 | | | | D*\|C* | D*\|C* | |
| 5 | E*\|C*, B\hat{ }, A* | | | E*\|C*, B\hat{ }, A* | | |
| 6 | | F*\|E*, C*, | F*\|E*, C*, | | | |
| | | B\hat{ }, A* | B\hat{ }, A* | | | |
| 7 | G*\|D*, C* | | | | | G*\|D*, C* |
| 8 | | H*\|G*, D*, C* | H*\|G*, D*, C* | | H*\|G*, | |
| | | | | | D*, C* | |
| 9 | | | | I\hat{ }\|H*, G*, | I\hat{ }\|H*, | |
| | | | | D*, C* | G*, D*, C* | |
| 10 | | | J*\|I\hat{ }, H*, G*, | | | J*\|I\hat{ }, H*, |
| | | | D*, C* | | | G*, |
| | | | | | | D*, C* |
| 11 | K*\|J* | | | K*\|J* | | |
| 12 | L*\|F*, E*, C*, | | | L*\|F*, E*, | | |
| | B\hat{ }, A* | | | C*, B\hat{ }, A* | | |

Description:
1. Harry sends S-Mail to Bob and allows it to be forwarded.
2. Bob replies to it, but makes it non-forwardable.
3. Harry replies, making his submessage forwardable.
4. Bob forwards the S-Mail to Carol, but only C is forwarded because Bob had made B non-forwardable.
5. Bob replies to Harry, and because it is part of a reply chain, the whole history is included. It is a reply, not a forward.
6. Harry replies, making his submessage forwardable again.
7. Carol replies to Harry, but in the S-Mail Harry receives, he can only see D and C. Carol could not forward B and A because she never received them.
8. Harry now forwards the S-Mail with a reply to both Bob and Carol at the same time. This would be analogous in email to CC-ing someone in on a reply.
9. Bob decides to pass comment on Harry's reply to Carol. He makes the forwarded submessage non-forwardable.
10. Carol now replies to Bob, allowing her submessage to be forwarded.
11. Bob now forwards to Harry, allowing his submessage to be forwarded. The only history that appears is J, because Carol made I non-forwardable.
12. Bob then finally gets round to replying about submessage F. In the history, because this is still part of a reply loop and has never lost the history through a partial forward, all the history back to A is shown.

When Bob forwards the S-Mail to Carol in action 4, the history is lost beyond the most recent submessage, because B was not forwardable. But Bob may still get new S-Mails later where the history is intact, e.g. in action 6. Compare actions 6 and 8, where the latter does not contain the submessages A and B as part of the S-Mail history.

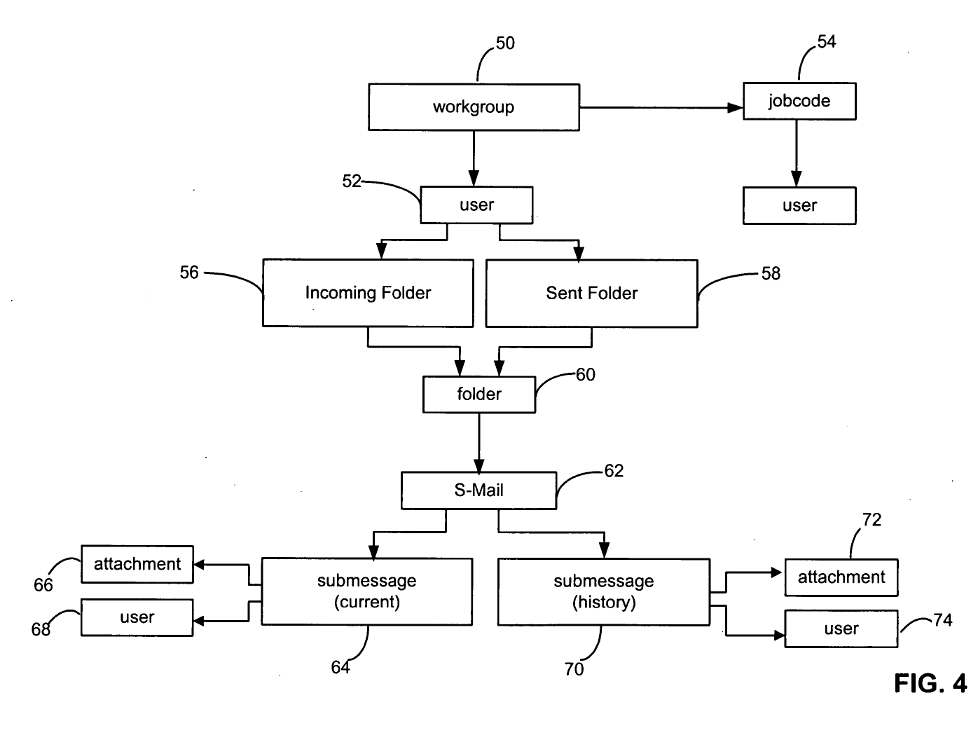

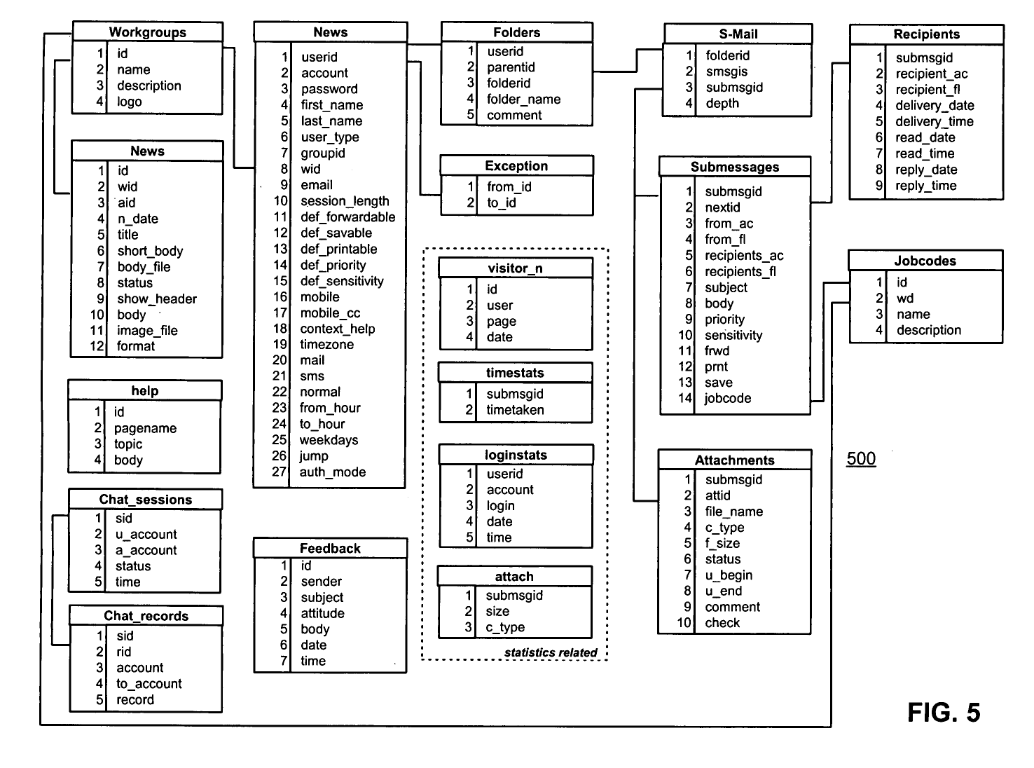

FIG. 4 is a block diagram illustrating modules and relationships within the secure message system 110 for handling S-Mails according to one embodiment. These modules and relationships are preferably implemented through logical arrangement and configuration of the data in the various modules of the database module 114. FIG. 5 is a block diagram illustrating a more detailed view 500 of the configuration of data in the database module 114 according to one embodiment.

A workgroup 50 is defined as an entity which represents a collection of end-users 52. A workgroup may represent for example an individual company or professional firm, and is defined as follows:

Workgroup

| Property | description |
|---|---|
| Name | a label for the workgroup, such as the name of the |
| | organization it is related to. |
| description | a short description of what the organization is, or the |
| | function it performs, e.g. ‘a corporate finance |
| | institute’. |
| Address | a suitably formatted street address including the |
| | necessary level of detail for the application. |
| Email | a contact e-mail address. |
| Phone | a contact telephone number. |
| URL | the URL of the website for the organization. |

The end-users 52 will typically represent individuals. They may be divided into two or more separate classes, namely “enterprise user” (for example a professional working within the firm defined by the workgroup) and “enterprise customer” (a customer of that firm). Formally, an end-user 52 may be defined as follows:

User

| Property | Description |
|---|---|
| login id | an identification of a minimum length which will uniquely |
| | identify the user within a particular workgroup. This will be |
| | used to identify the user during the login process. |
| screen | usually the name of the user, e.g. ‘Robert Marley’. |
| name | |
| user class | a user can be one of two classes of user: ‘enterprise user’, for |
| | professionals in an enterprise such as lawyers, accountants and |
| | so on, and ‘enterprise customer’ for their customers. |
| admin | a user can be granted admin privileges which allow the user to |
| user | alter workgroup settings such as jobcodes and permitted |
| | communication within the workgroup. |
| email | the user's e-mail address. This will be used to send |
| | informational e-mails by the system. |
| mobile | the user's SMS-capable mobile number. This will be used by |
| | the system to send informational SMSs. |
| address | a contact address. |
| homepage | the user's homepage. |

Other information stored about an end-user may include flags to determine whether the email address, mobile number, street address and home page are viewable by other members of the workgroup.

In one embodiment, an end-user is a member of exactly one workgroup, and is assigned membership of that workgroup. In one embodiment, the rules for default permitted communication within a workgroup are as follows:

a) all enterprise users (EU) can contact all enterprise customers (EC);

b) all EUs can contact all other EUs;

c) all ECs can contact all EUs; and

d) no ECs can contact any other ECs.

Changing default behavior is possible, and is changeable by EUs who are also administrators. This allows any combination of communication between EUs and ECs in the same workgroup.

In addition, end-users can be granted permission to contact other end-users in another workgroup, and this is dealt with by a system administrator (who manages all the workgroups). There is also an end-user per workgroup who is defined as the “workgroup contact.” This is an end-user who is responsible for the workgroup, and all queries relating to the workgroup can be directed to this end-user. In one embodiment, end-user to end-user relationships are represented with a “direction” property which can take one of three values representing a→b, a←b or a⇄b. That is, a→b allows end-user a to have access to end-user b, a←b allows end-user b to have access to end-user a, and a⇄b allows access in both directions.

In one embodiment all of the end-users in a workgroup can by default send S-Mails to each other. However, in order to send an S-Mail to an end-user outside of the workgroup, an end-user needs explicit permission from the system administrator or from the intended recipient. For example, a workgroup can include all of the employees of a law firm. By default, the employees of a law firm can exchange S-Mails with each other. However, an employee needs explicit permission from a supervisor and/or a client of the firm before gaining the ability to exchange S-Mails with the client.

As illustrated by the embodiments described above, the permissioning capabilities of the system 110 allow ethical screens to be created between certain end-users. Such screens are desirable, for example, in a law firm environment where certain attorneys are prohibited from sharing data with other attorneys for ethical reasons. The system 110 can be configured so that S-Mails, attachments, and other information created by a first attorney are not accessible to a second attorney on the other side of an ethical screen, even if the information is forwarded to multiple parties before an attempt is made to forward it to the second attorney.

A workgroup can have an associated set of jobcodes 54 which are used to track time spent on a particular job. This is a mapping between workgroup and jobcode (workgroup, jobcode).

Job Code

| property | description |
|---|---|
| creator | reference to the user who created this jobcode. |
| description | a short description of the use of this jobcode. This |
| | might include advice on when to use this jobcode. |

A mapping is stored in the database module 114 of which end-users ajobcode is applied to as a list of (user, jobcode) pairs allowing a jobcode to be associated with many end-users. A mapping is also stored to indicate which submessages a jobcode has been assigned to. Again, this is a list of pairs: (jobcode, submessage) meaning a jobcode can be applied to many submessages. In addition, a submessage can have multiple jobcodes applied to it.

A folder contains the results of a specified query on the data in the database 114. The query can retrieve and/or sort the data in the database 114 based on any one or more of the properties of the data. For example, a query can identify S-Mails based on any of the priorities of the S-Mail, including author, subject, body, priority, job code, recipient, existence of an attachment, etc. A query can also identify attachments based on properties of the attachments. In addition, a query can also represent a logical combination of two or more sub-queries. Thus, a query could identify all attachments of messages sent or received by a particular end-user. The data describing the folders, including the queries, the end-users who created the folders, and the dates and times on which the folders were created and last accessed are preferably stored in the database 114.

In one embodiment an end-user by default has two folders: “incoming” and “sent.” The “incoming” folder (e.g., the “inbox”) is a-query on the database 114 that identifies the S-Mails addressed to that end-user while the “sent” folder (e.g., the “outbox”) is a query on the database 114 that identifies the S-Mails sent by the end-user. Due to the nature of the database 114, the end-user cannot delete or move messages to/from these folders. However, the end-user can preferably perform other tasks to make the folders easier to use. For example, in one embodiment the end-user can create sub-folders beneath the incoming, sent, or other folders and transfer S-Mails to these folders. In addition, the end-user can also hide S-Mails so that they no longer appear in a folder. In one embodiment, information on whether to hide or display messages is stored as an extension of the query that describes the data in the folder. In another embodiment, each folder has data separate from the query that describe the display characteristics of the folder.

In one embodiment, the system 110 provides the end-users with a graphical user interface with which the end-users can easily create custom folders and assign custom queries to the folders. The end-user can also assign labels and descriptions to the folders. For example, the end-user can create a folder for holding email correspondence with a particular recipient, and define a query for that folder which identifies S-Mails in the database that were sent to, or received from, that recipient.

Each S-Mail has one current submessage 64 which may have a number of different attachments 66. The current submessage may also have multiple recipients 68.

Each S-Mail 62 may have a number of history submessages 70, each of which may have a number of attachments 72. Each history submessage may also have multiple recipients 74.

The exact design of the end-user front end by which the described functionality may be accessed depends upon the embodiment and access method (e.g., whether the client accesses the system 110 via a web-based or email-based method). Typically, however, after passing through the usual login and authentication screens, end-users will have access to screens for generating and viewing S-Mails, accessing statistical information, creating and viewing folders, and carrying out administrative functions.

Typically, a top-level view will provide access to a list of folders, including the inbox, sent items folders, inbox trash and outbox trash.

On opening a folder, the S-Mails within that folder are displayed, along with summary information. Exactly what is shown will depend upon whether the current folder is part of the incoming or outgoing folder collection. The fields shown may include:

| Field | Description |
|---|---|
| Author | Displayed if the folder is an incoming folder, indicates |
| | the author of the message. |
| Recipient(s) | Displayed if the folder is an outgoing folder, displays the |
| | recipient(s) of the message. This can be truncated to save |
| | space. |
| Subject | The subject of the message. If the length of the subject is |
| | aesthetically too long, then truncation of the subject is |
| | allowed in this view, for example, “the meetings on the |
| | fourth of January” would be truncated to ‘the meetings |
| | on...’. |
| You Received | Displayed if the folder is an incoming folder, indicating |
| | when the message was received. |
| Delivered | Displayed if the folder is an outgoing folder, indicating |
| | when the message was sent. |
| You read or | If the folder is an incoming folder, then this relates to |
| They read | the date when the user themselves read the S-mail. If the |
| | folder is an outgoing folder, then this relates to the date |
| | the recipient(s) read the S-mail. If the S-mail was sent to |
| | more than one recipient, the first date that a recipient |
| | read the S-mail should be shown with a link “[more]” or |
| | “[#]” or similar underneath the first date, which gives |
| | a popup window listing recipients and read dates. |
| You replied to | If the folder is an incoming folder, then this relates to the |
| or They | date when the user themselves replied to the S-mail. If |
| replied to | the folder is an outgoing folder, then this relates to the |
| | date the recipient(s) replied to the S-mail. If the S-mail |
| | was sent to more than one recipient, the first date that a |
| | recipient replied to the S-mail should be shown with a |
| | link “[more]” or “[#]” or similar underneath the first |
| | date, which gives a popup window listing recipients and |
| | the dates they replied to the S-mail. |
| Priority | This will be on a scale of 1 (low priority) to 5 (high |
| | priority - appropriate coloring may be used. |
| Sensitivity | This will be on a scale of 1 (not sensitive) to 5 (very |
| | sensitive) - appropriate coloring may be used. |
| Details | See table below. |
| Attachments | The number of attachments (and size) associated with |
| | the S-mail. |

Also, the following details may be shown by means of suitable icons:

| Icon | Meaning |
|---|---|
| Forwardable | The end-user is allowed to forward this S-mail to other |
| | users. |
| Non- | The end-user is not allowed to forward this S-mail to other |
| Forwardable | users, and that option will not be displayed. |
| Printable | The end-user is allowed to print hard copies of this S-mail. |
| | Some method should be employed to make the S-mail easy |
| | to print, i.e. a “printer-friendly” link. |
| Non- | The end-user is not allowed to print hard copies of this S- |
| Printable | mail, and the message will be displayed in such a way to |
| | minimize the likelihood that they will do so. One method of |
| | achieving is to display the message body in a java applet |
| | which only displays the text when the mouse is over it, |
| | whilst another would be to render the text as a GIF file with |
| | transparent foreground on top of a table with black cell fill. |
| Savable | The user is allowed to save plain text copies of the |
| | message. Attachments are exempt from this category. |
| | This is achieved by providing a link that will allow |
| | the end-user to view the document |
| | in text/plain format. |
| Non-Savable | The link described in ‘savable’ is not provided |

Each message entry (that is, each row in the table) has a checkbox that will indicate whether the end-user wishes to apply an action to that message. The actions that are available to the end-user are also indicated underneath all the messages along with a button to apply the action. In one embodiment, the possible actions are:

| Action | Description |
|---|---|
| Delete | Move references to the S-mail(s) to the appropriate |
| | trash folder (i.e. if the S-mails are received S-mails, |
| | then they move to the trash folder in the incoming |
| | collection). |
| Delete and Shred | Remove the reference to the S-mail(s) from all the |
| | folder(s). |
| Move to . . . | For each folder in the current collection (i.e. if the |
| | current folder is in the incoming collection, then |
| | only incoming folder are shown) list them to allow |
| | the S-mail references to be moved to other folders. |

Selecting one of the S-Mails opens it for viewing. From there, buttons are provided allowing the end-user to reply and/or forward the message. Statistics screens may be provided to provide information on, for example, the amount of time that an end-user has spent on different tasks within the system. This utilizes time stamping. There are two desiderata:

(1) Timing the length of time from the creation of an S-Mail (that is, selecting the compose button) to its sending (that is, selecting the send button).

(2) Timing how long the end-user has been using the system. Information regarding each login should be available, and appropriate knowledge of the user's timeout preferences should be taken into account. In one embodiment, every event in the system 110 is timestamped and audited.

Timestamping also allows an author of an S-Mail to request notification (for example by email) if the recipient has not accessed it within an allotted time period.

Tracking of the visibility of a submessage by the author of that submessage is also desirable. An author selects a submessage that he still has a reference to, and then selects ‘view readership’ which then provides the following details:

A summary of the number of people who have read the submessage.

Exactly who has read the submessage.

When they first read it.

Who users have forwarded the submessage to.

An author of a submessage (contained within many S-Mails and seen by different end-users, through forwarding etc.) could request a recipient visualization, which will show a web of all users who have been able to view that submessage, along with the route by which they received it, all accompanied by data-stamps. In one embodiment, this visualization is generated by updating information for each submessage object when a user reads a message as part of a forward, etc.

Statistics may also be provided, for the system administrator, for example:

How much time have users spent in S-mailing?

How much time has user X spent?

How much time has a user spent on composing S-Mails?

How much time has been spent on composing S-Mails which relate to Jobcode X?

In conclusion, the messaging system 110 provides a relational data store that can be flexibly, inexpensively, and easily integrated into an enterprise environment in order to capture the enterprise's workflow. The messaging system 110 includes permissioning features that allow ethical screens and other security procedures. Moreover, the relational nature of the data store, combining with comprehensive logging procedures, enable the system 110 to support rigorous auditing and compliance capabilities.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A messaging system for providing messaging to end-users, the system comprising:
a data store module for storing messages sent among the end-users, wherein each message includes one or more submessages and wherein the data store stores the messages and submessages in a relational manner.

2. The messaging system of claim 1, wherein the data store module comprises:
a contents module adapted to store submessages of the messages sent among the end-users, wherein a message sent by a sender to a recipient includes one or more references to submessages in the contents module.

3. The messaging system of claim 2, wherein the contents module stores a plurality of submessages and wherein certain ones of the submessages are created by different end-users at different times.

4. The messaging system of claim 1, wherein the data store module stores only a single version of each message and/or submessage.

5. The messaging system of claim 1, further comprising:
an attributes module for storing attributes of the messages and/or submessages in the data store.

6. The messaging system of claim 5, wherein the attributes module is adapted to store an attribute indicating a length of time that a message and/or submessage is retained.

7. The messaging system of claim 5, wherein the attributes module is adapted to store an attribute indicating a length of time that a message and/or submessage is valid.

8. The messaging system of claim 5, wherein the attributes module is adapted to store an attribute indicating security information for a message and/or submessage.

9. The messaging system of claim 5, wherein the attributes module is adapted to store an attribute indicating whether a message and/or submessage can be viewed by a given end-user.

10. The messaging system of claim 1, further comprising:
a relationships module for holding data describing relationships among the messages and submessages.

11. The messaging system of claim 10, wherein the relationships module is adapted to hold data describing submessages within a message.

12. The messaging system of claim 1, further comprising:
a client interface module for interfacing with client applications utilized by the end-users to access the messaging system.

13. A computer program product comprising:
a computer-readable medium having computer program logic embodied therein for providing messaging to end-users, the system comprising:
a data store module for storing messages sent among the end-users, wherein each message includes one or more submessages and wherein the data store stores the messages and submessages in a relational manner.

14. The computer program product of claim 13, wherein the data store module comprises:
a contents module adapted to store submessages of the messages sent among the end-users, wherein a message sent by a sender to a recipient includes one or more references to submessages in the contents module.

15. The computer program product of claim 14, wherein the contents module stores a plurality of submessages and wherein certain ones of the submessages are created by different end-users at different times.

16. The computer program product of claim 13, wherein the data store module stores only a single version of each message and/or submessage.

17. The computer program product of claim 13, further comprising:
an attributes module for storing attributes of the messages and/or submessages in the data store.

18. The computer program product of claim 17, wherein the attributes module is adapted to store an attribute indicating a length of time that a message and/or submessage is retained.

19. The computer program product of claim 17, wherein the attributes module is adapted to store an attribute indicating a length of time that a message and/or submessage is valid.

20. The computer program product of claim 17, wherein the attributes module is adapted to store an attribute indicating security information for a message and/or submessage.

21. The computer program product of claim 17, wherein the attributes module is adapted to store an attribute indicating whether a message and/or submessage can be viewed by a given end-user.

22. The computer program product of claim 13, further comprising:
a relationships module for holding data describing relationships among the messages and submessages.

23. The computer program product of claim 22, wherein the relationships module is adapted to hold data describing submessages within a message.

24. The computer program product of claim 13, further comprising:
a client interface module for interfacing with client applications utilized by the end-users to access the messaging system.

25. A computer-implemented method of providing messaging to end-users, comprising:
storing messages sent among the end-users in a data store of a messaging system, wherein each message includes one or more submessages and wherein the data store stores the messages and submessages in a relational manner.

26. The computer-implemented method of claim 25, further comprising:
defining an attributes module in the messaging system, the attributes module for storing attributes of the messages and/or submessages in the data store.

27. The computer-implemented method of claim 26, wherein the attributes module is adapted to store an attribute indicating a length of time that a message and/or submessage is retained.

28. The computer-implemented method of claim 26, wherein the attributes module is adapted to store an attribute indicating a length of time that a message and/or submessage is valid.

29. The computer-implemented method of claim 26, wherein the attributes module is adapted to store an attribute indicating security information for a message and/or submessage.

30. The computer-implemented method of claim 26, wherein the attributes module is adapted to store an attribute indicating whether a message and/or submessage can be viewed by a given end-user.

31. The computer-implemented method of claim 25, further comprising:
defining a relationships module in the messaging system, the relationships module for holding data describing relationships among the messages and submessages.

32. The computer-implemented method of claim 31, wherein the relationships module is adapted to hold data describing submessages within a message.
